(19) United States
(12) Patent Application Publication
(10) Pub. No.: US 2026/0051028 A1
(43) Pub. Date: Feb. 19, 2026

(54) IMAGE PROCESSING METHOD, ELECTRONIC DEVICE AND STORAGE MEDIUM

(71) Applicant: Beijing Zitiao Network Technology Co., Ltd., Beijing (CN)

(72) Inventor: Yuanlue ZHU, Beijing (CN)

(21) Appl. No.: 19/301,051

(22) Filed: Aug. 15, 2025

(30) Foreign Application Priority Data
Aug. 16, 2024 (CN) 202411132123.0

(51) Int. Cl. G06T 5/50; G06T 7/11; G06T 11/00

(52) U.S. Cl. CPC G06T 5/50; G06T 7/11; G06T 11/001; G06T 2207/10024; G06T 2210/22

(57) ABSTRACT

The present disclosure provides a method for image processing, an electronic device, and a storage medium. And the method includes: obtaining an original image and a color-changing prompt text, and determining a color-changing object mask image of the original image; cropping the color-changing object mask image and the original image to obtain respectively a mask cropped image and an original cropped image containing a color-changing object; generating a color-changing result image according to the mask cropped image, the original cropped image and the color-changing prompt text; and generating a target result image according to fusion processing of the color-changing result image and the original image.

### CROSS-REFERENCE TO RELATED APPLICATION

This application claims the priority to and benefits of Chinese Patent Application No. 202411132123.0, filed on Aug. 16, 2024. All the aforementioned patent applications are hereby incorporated by reference in their entireties.

### TECHNICAL FIELD

Embodiments of the present disclosure relate to a method for image processing, an electronic device, and a storage medium.

### BACKGROUND

Currently, image processing for effect enhancement of images has been widely applied in daily life. For example, specific objects in an image can be recolored, such as hair in the image.

Taking a hair color-changing effect as an example, current models only support one or a limited number of replaceable colors, restricting the variety of available color-changing options and failing to achieve flexible hair color replacement. Furthermore, existing methods also have the problem of not obvious or unnatural hair color-changing effects. The existing hair color-changing methods limit the range of effect enhancement and degrade user experience.

### SUMMARY

The present disclosure provides a method for image processing, an apparatus, an electronic device, a storage medium, and a computer program product.

The embodiment of the disclosure provides a method for image processing, and the method includes: obtaining an original image and a color-changing prompt text, and determining a color-changing object mask image of the original image; cropping the color-changing object mask image and the original image to obtain respectively a mask cropped image and an original cropped image containing a color-changing object; generating a color-changing result image according to the mask cropped image, the original cropped image and the color-changing prompt text; and generating a target result image according to fusion processing of the color-changing result image and the original image.

The embodiment of the disclosure provides an image processing apparatus, and the apparatus includes an information determination module, an image cropping module, a first generation module and a second generation module.

The information determination module is configured to obtain an original image and a color-changing prompt text, and determine a color-changing object mask image of the original image.

The image cropping module is configured to crop the color-changing object mask image and the original image to obtain respectively a mask cropped image and an original cropped image containing a color-changing object.

The first generation module is configured to generate a color-changing result image according to the mask cropped image, the original cropped image and the color-changing prompt text.

The second generation module is configured to generate a target result image according to fusion processing of the color-changing result image and the original image.

The embodiment of the disclosure provides an electronic device, and the electronic device includes: at least one processor and a storage apparatus.

The storage apparatus is configured to store at least one program, where when the at least one program is executed by the at least one processor, the at least one processor is caused to implement the method for image processing according to any embodiment of the present disclosure.

The embodiment of the disclosure provides a computer-readable storage medium having stored thereon a computer program, where the program, when executed by a processor, implements the method for image processing according to any embodiment of the present disclosure.

The embodiment of the disclosure provides a computer program product, including a computer program, which, when executed by a processor, is used to implement the method for image processing according to any embodiment of the present disclosure.

### BRIEF DESCRIPTION OF DRAWINGS

The above and other features, advantages, and aspects of embodiments of the present disclosure will become more apparent from the following detailed description when taken in conjunction with the drawings. Throughout the drawings, the same or similar reference numerals indicate the same or similar elements. It should be understood that the drawings are schematic and that components and elements are not necessarily drawn to scale.

FIG. 1a shows a flow diagram of a method for image processing provided by an embodiment of the present disclosure;

FIG. 1b shows an example diagram of an original image in the method for image processing provided by the embodiment of the present disclosure;

FIG. 1c shows an effect display diagram of a target result image in the method for image processing provided by the embodiment of the present disclosure;

FIG. 1d shows another effect display diagram of the target result image in the method for image processing provided by the embodiment of the present disclosure;

FIG. 2 is a schematic structural diagram of an image processing apparatus provided by an embodiment of the present disclosure; and

FIG. 3 is a schematic structural diagram of an electronic device provided by an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be embodied in various forms and should not be construed as limited to the embodiments set forth here, but rather, these embodiments are provided for a more thorough and complete understanding of the present disclosure. It should be understood that the drawings and the embodiments of the present disclosure are for illustration purposes only and are not intended to limit the scope of the present disclosure.

It should be understood that the steps described in the method embodiments of the present disclosure may be performed in a different order and/or in parallel. Furthermore, the method embodiments may include additional steps and/or omit performing the illustrated steps. The scope of the present disclosure is not limited in this respect.

As used herein, the term “comprising” and its variants are inclusive, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Related definitions of other terms will be given in the following description.

It is noted that the terms “first”, “second”, and the like in the present disclosure are only used for distinguishing different apparatuses, modules or units, and are not used for limiting the order or interdependence of the functions performed by these apparatuses, modules or units.

It is noted that references to “a” or “an” or “a plurality of” in the present disclosure are intended to be illustrative rather than limiting, and should be understood as “one or more” by those skilled in the art, unless the context clearly indicates otherwise.

The names of messages or information exchanged between apparatuses in the embodiments of the present disclosure are for illustrative purposes only, and are not intended to limit the scope of the messages or information.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as an electronic device, an application program, a server or a storage medium that performs the operations of the technical solution of the present disclosure according to the prompt information.

As an optional but non-limiting implementation, in response to receiving the active request of the user, the prompt information may be sent to the user by, for example, a pop-up window, in which the prompt information can be presented in the form of text. Furthermore, the pop-up window can also carry a selection control for the user to choose “agree” or “disagree” to provide personal information to the electronic device.

It can be understood that the above process of notifying and obtaining user authorization is only schematic, and does not limit the implementation of the present disclosure, and other ways meeting relevant laws and regulations can also be applied to the implementation of the present disclosure.

It can be understood that data referred to in this technical solution (including but not limited to the data itself, the acquisition or use of the data) should comply with the requirements of the applicable laws and regulations and related regulations.

It should be noted that in some entertainment applications, it often has functions of enhancing and editing images or even videos. One type of effect enhancement application is particularly evident in the implementation of color changing of human hair or animal fur in images. In existing color-changing implementations, it is often only possible to apply one or a limited number of color-changing options to a color-changing object. Moreover, a color-changing result tend to be either insufficiently noticeable or unnatural compared to an original image. Meanwhile, the restriction to just one or a limited number of color-changing options limits the scope for effect enhancements, which in turn fails to provide players with better operation experience.

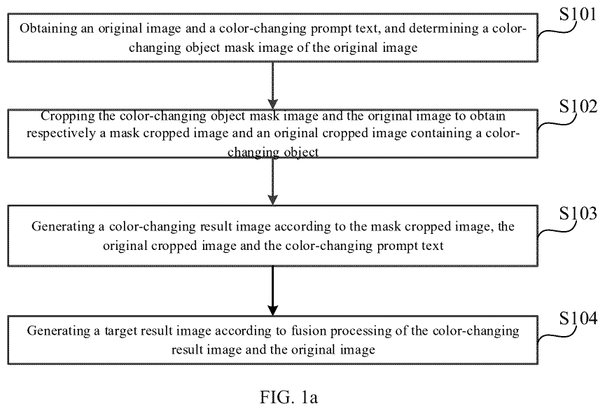

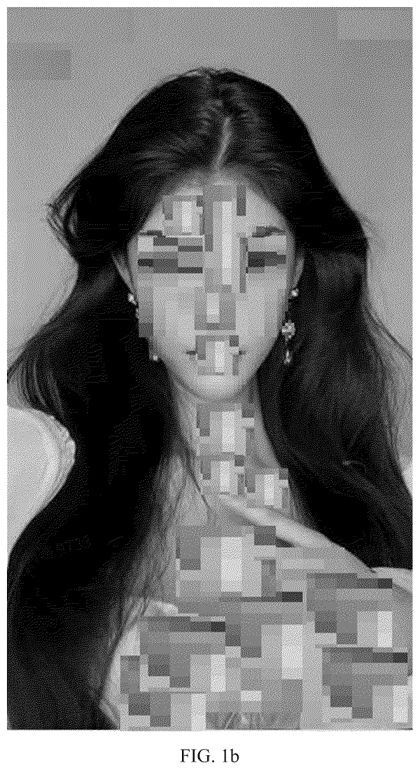

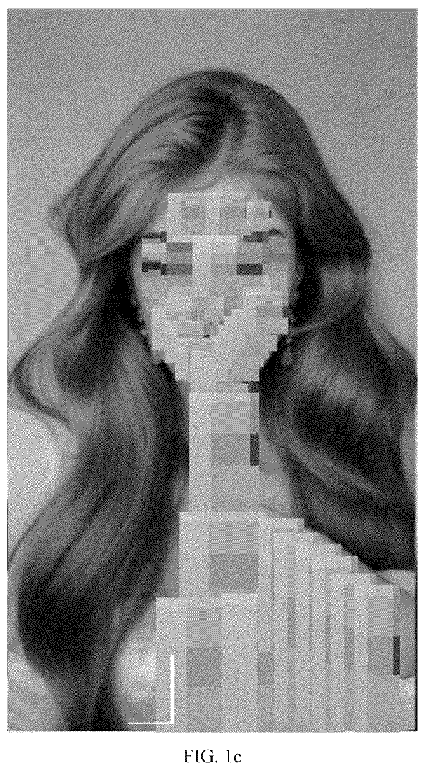

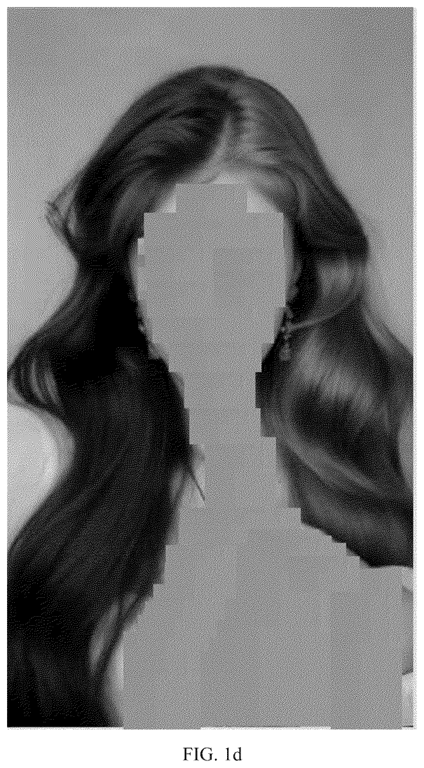

On such a basis, an embodiment of the present disclosure provides a method for image processing. FIG. 1a shows a flow diagram of a method for image processing provided by the embodiment of the present disclosure. The embodiment of the present disclosure is suitable for the case of color changing of the color-changing objects in the image. This method can be implemented by an image processing apparatus, which may be implemented in the form of software and/or hardware. Optionally, the apparatus can be implemented through an electronic device, which preferably may be a mobile terminal, a desktop computer, a laptop, a server, or the like.

As shown in FIG. 1a, the method for image processing provided by the embodiment of the present disclosure may specifically include:
S101: obtaining an original image and a color-changing prompt text, and determining a color-changing object mask image of the original image.

It should be noted that the method for image processing provided in this embodiment can be used as a plug-in in an effect enhancement editing application, and the method for image processing provided in this embodiment can be started after the effect enhancement editing application is triggered. Furthermore, the method provided in this embodiment can also be regarded as a replacement function for an image effect enhancement function in a certain application, and the method for image processing provided in this embodiment can also be started after an image processing function control in application software is triggered.

As an exemplary implementation, an executing subject of the method provided in this embodiment can be regarded as a server that responds to a processing request submitted by an application client. The executing subject can trigger the execution of the method provided in this embodiment through a request or message sent by the application client.

In this embodiment, the original image can be understood as one or more images selected after an image processing operation is started, and it may be considered that the original image contains a color-changing region with color-changing requirements, and the color-changing region can be regarded as a color-changing object in the original image. Exemplarily, the original image may be an image directly captured by an image capture apparatus on an executing device, or an image selected from images stored in the executing device (such as a computer or a mobile device). The original image is usually stored with high resolution and high color depth, and can be saved in a lossless image format, such as RAW, TIFF or PNG, so as to preserve as much image information as possible in the original image.

In this embodiment, the color-changing object can be considered as a region or an element in the original image that needs color changing, which can be any identifiable part in the original image. Exemplarily, it can be a specific object in an image, such as hair of real or fictional characters, or fur of animals like cats and dogs; it can also be a region in the original image that contains specific colors, such as all regions in the image that match with colors such as red or black; it can also be a specific texture or pattern in the original image; or it can be a specific background or foreground.

In this embodiment, the color-changing prompt text can be regarded as a type of instructional text information, which is used to indicate specific objects, regions and desired color effects that require color changing during image processing. This type of text can be a simple description, such as “change the puppy's fur color to gold” or “change the virtual character's hair color to half red and half green”; or more specific instruction descriptions, such as specific description information as follows: “create a linear gradient effect starting from the top of the virtual character's head to the ends of the hair on both sides; starting color: bright orange with the transparency of 100%; end color: blue with the transparency of 50%; the gradient effect should cover a whole hair region; the gradual transition needs to be smooth without obvious color bands; there is no need to add reflection or luminous effects”.

In this embodiment, a pre-configuration method of the color-changing prompt text may involve triggering a provided effect item tool, such as a color picker or an object selection tool, to assist in generating a corresponding color-changing prompt text after a user submits an original image, or involve manually editing the color-changing prompt text according to requirements when the user submits information, where the object requiring color changing, the range, and other information are described in detail.

In this embodiment, the color-changing object mask image can be understood as an image of the equal size as the original but with only two states, that is generated by applying an image segmentation technology, such as threshold-based segmentation or clustering algorithms, to divide the original image into different regions, using different pixel values to distinguish between regions that require replacement and those that do not, with 0 and 1 representing pixel visibility or selection states, and identifying a color-changing object region, and that is used to mark the specific regions in the original image where color replacement is needed. For example, in the field of face recognition, when the user wants to perform a hair color-changing operation, the color-changing region is hair, which is characterized by 0, and other non-color-changing regions, such as a background and a human face, characterized by 1. Here, 0 denotes white and 1 denotes black. The resulting binary mask image, generated using these 0 and 1 values, will isolate the hair region, namely the white region.

In this embodiment, by taking the executing subject as a server of a certain application client as an example, the first step involves obtaining information such as an original image uploaded by the application client and the color-changing prompt text. Additionally, operations like masking the original image relative to the color-changing object can be performed. The original image can be obtained by the application client through direct capture or by selecting and importing from external sources. Subsequently, the color-changing prompt text can be obtained, which may be formed by the player through editing or configuration within the application client. Alternatively, after the color-changing requirements for the color-changing object in the original image are selected, the color-changing prompt text can be directly provided by the effect item tool within the application client.

Following the above description, this step can also determine the color-changing object that requires color changing from the original image according to the description of the content of the color-changing prompt text, and can identify the region of the color-changing object from the obtained original image through image segmentation and other technologies. Subsequently, binarization processing can be applied, with 0 and 1 being used to distinguish and represent pixels of the region to which the color-changing object belongs and pixels of the region to which the non-color-changing object belongs, ultimately generating the color-changing object mask image.
S102: cropping the color-changing object mask image and the original image to obtain respectively a mask cropped image and an original cropped image containing a color-changing object.

In this embodiment, the mask cropped image of the color-changing object can be regarded as an image formed by cropping the color-changing object mask image, which displays an outline of the color-changing region. The mask cropped image retains only parts where the color-changing object and the associated object exist, and all other parts can be cropped away, which is equivalent to obtaining a to-be-input image that is better suited for a big data model used in image color changing through the processing in this step.

In this embodiment, the original cropped image may be an image obtained by selecting and cropping a main body region including a color-changing object from the obtained original image, and includes the actual image content. An image size of the original image formed after cropping should be a size that can be inputted into the above-mentioned big data model for processing. In this embodiment, it is preferable to set the sizes of the original cropped image and the mask cropped image to be consistent to ensure that they can correspond to each other.

In this embodiment, cropping positions for the color-changing object mask image and the original image can be determined according to position information of the color-changing object and an object position of an object associated with the color-changing object, and the object position of the object associated with the color-changing object can be ensured to be located in a prominent or central position of the cropped image during specific cropping, facilitating further processing or meeting specific visual requirements. For example, when performing a hair color changing operation on a character, during the cropping step, the character associated with the hair can be placed on a layer with the cropping size, and centered horizontally, and it is ensured that the hair (as the color-changing object) maintains a suitable distance from a top edge of the layer.

In this embodiment, the object position of the object associated with the color-changing object can be determined according to the position information of the color-changing object, then the object position can be used as the cropping position, and the associated object can be cut out and placed in the layer constructed with the set cropping size according to the above description, thus forming the original cropped image of the original image and the mask cropped image of the color-changing object mask image, where it ensures that the object associated with the color-changing object after cropping is located in the central position of the mask cropped image and the original cropped image. This cropping method can ensure that the color-changing object and its associated object have more suitable sizes for processing. When the color-changing object occupies a small region or is in a concealed position in the original image, directly processing the original image may not yield desired results.
S103: generating a color-changing result image according to the mask cropped image, the original cropped image and the color-changing prompt text.

In this embodiment, the color-changing result image can be understood as an image obtained by performing a color replacement operation on the color-changing object in the original cropped image, and the color-changing result image demonstrates that the color of the region where the color-changing object is located in the original cropped image is replaced with the desired color specified in the color-changing prompt text.

In this embodiment, the generation of the color-changing result image can be realized by inputting the obtained mask cropped image, the original cropped image and the color-changing prompt text into a generative big data model (such as an AIGC network). Specifically, through the generative big data model, the content described in the input color-changing prompt text can be semantically analyzed, and the expected requirements of the color-changing result image to be generated can be understood. Different objects in the original cropped image are determined to be processed by different ways and different degrees of noise-adding processing based on the requirements, according to the mask cropped image. For example, for a non-color-changing object, conventional noise-adding processing is directly performed; for the color-changing object, this part of original pixels is first eliminated, and then processed by noise-adding processing, and the noise type is selected according to specific requirements and objectives.

Following the above description, the noise-added image after can be denoised through the generative big data model. In order to ensure the quality and color accuracy of the color-changed image, noise-adding and denoising operations can be performed circularly in the generative big data model until the last iteration process is reached, and finally the denoised feature map corresponding to the original cropped image is outputted, where the obtaining of the denoised feature map through the above-mentioned series of operations means the completion of color changing in the region where the color-changing object is located; in order to achieve the natural connection between the color-changed region and contents of other regions of the original image, this embodiment can also perform fusion processing on the output denoised feature map and the original cropped image according to the mask cropped image to blur a boundary between the color-changing region and the adjacent region, so as to generate a more realistic and natural color-changing result image.

It should be noted that the number of color-changing prompt texts received in this embodiment may not be limited to 1. When there is a requirement for the color-changing object to simultaneously display at least two changed colors, each color can correspond to a separate color-changing prompt text relative to the multiple colors to be displayed. When the number of color-changing prompt texts is not unique, each color-changing prompt text can be combined with the original cropped image and the mask cropped image respectively, and the color-changing result image corresponding to the expected color in the color-changing prompt text can be generated through the above description of this embodiment.

Therefore, for the color-changing prompt text obtained in this embodiment, a corresponding color-changing result image can be generated for each color-changing prompt text, and the color-changing object included in the color-changing result image can present related colors of color information described in the color-changing prompt text.
S104: generating a target result image according to fusion processing of the color-changing result image and the original image.

In this embodiment, the color-changing result image determined through the above steps still needs to be fused with the original image in this step. The reason can be explained as follows. On the one hand, because the color-changing result image can be regarded as determined relative to the original cropped image, it is necessary to fuse a color-changing result into a corresponding region of the original image. On the other hand, when there is a requirement of presenting multiple colors relatively to the color-changing object at the same time, it is equivalent to the existence of multiple color-changing prompt texts and the color-changing result image outputted corresponding to each color-changing prompt text. The color-changing contents presented in these color-changing result images need to be reflected on the color-changing objects in the original image. Therefore, it is also necessary to fuse the color-changing content from each color-changing result image into the original image.

In this embodiment, as an implementation of fusion processing between the color-changing result image and the original image, when the number of color-changing result image is 1, feature information of the color-changing result image can be upsampled. This ensures that the upsampled color-changing result image contains more image feature information compatible with the original image. Specifically, for example, the color-changing result image can be inputted into a super-resolution network to continuously increase features, thereby obtaining an image with the equal size as the original image. Subsequently, a pre-determined first fusion coefficient map can be used to perform pixel-level information fusion between the upsampled color-changing result image and the original image. In this implementation, this embodiment can record the fused image as the target result image.

In this embodiment, as another implementation of fusion processing between the color-changing result image and the original image, when the number of color-changing result images is greater than 1, the aforementioned method can be used to perform feature information upsampling on each color-changing result image separately. Subsequently, the pre-determined first fusion coefficient map can also be used to perform pixel-level information fusion between the upsampled color-changing result image and the original image. The number of the fused images formed by fusion corresponds to that of the color-changing result images, and the color-changing object in each fused image has a different color.

In view of the fact that the equal color-changing object in the original image is expected to display multiple colors simultaneously, it is possible to achieve the above-mentioned effect by simultaneously fusing the colors possessed by the color-changing objects in each fused images into the original image.

Specifically, after the fused images are determined, which regions of the original image that the colors represented by the color-changing objects in the fused images should be represented by the color-changing objects in the original image are further determined, then the original image may be masked based on the corresponding different regions of the fused images in the original image, and finally, on the mask image formed by processing, final fusion processing is performed based on the fused images and a determined second fusion coefficient map, so that the color-changing objects can represent multiple changed colors in the formed target result image.

From a visualization perspective, an application implementation of the method for image processing provided by this embodiment can be described as follows: receiving the submitted or selected original image and the color-changing prompt text, and then processing the original image by the method for image processing provided by this embodiment to generate the color-changed target result image. This target result can be delivered to the application client and the target result image can be displayed in an image preview window of the application client. The target result image displayed in the image preview window can be considered as an image generated after the original image is processed by color changing according to the description content of the color-changing prompt text, and the color-changing object in the displayed image can present one changed color or two or even more changed colors. Moreover, through the presented color-changed image, it can be seen that the method for image processing provided by this embodiment can achieve the natural conversion of the target color for changing in the original image.

Exemplarily, FIG. 1b shows an example diagram of an original image in the method for image processing provided by the embodiment of the present disclosure. As shown in FIG. 1b, the original image presented includes a close-up photo of a character, and the hair in the close-up photo of the character can be regarded as a color-changing object with the color-changing requirement. It can be seen that the hair of the character in the original image appears as natural black.

It can be understood that when the received color-changing prompt text contains the description of the color-changing requirement, that is, changing hair to another color (such as green) and the detailed description of the color to be changed, and only one color-changing prompt text is received, then the original image can be processed by color changing based on the color-changing prompt text and the like by the method for image processing in this embodiment, and a target result image with green hair that naturally and truly present the changed color can be obtained.

Exemplarily, FIG. 1c shows an effect display diagram of a target result image in the method for image processing provided by the embodiment of the present disclosure. FIG. 1c can be regarded as an example diagram of a target result image generated by combining the original image shown in FIG. 1b with a color-changing prompt text for changing colors by using the method for image processing. As shown in FIG. 1c, in the close-up photo of the character included in the presented target result image, only the color of a hair region as the color-changing object has been changed, and the changed hair color can be more truly and naturally presented in the close-up photo of the character.

It can also be understood that when the number of received color-changing prompt texts is greater than 1, for example, when there are two, it is equivalent to expecting the ability to simultaneously change the hair color in the close-up photo of the character to two different colors. It can be considered that each color-changing prompt text describes a desired color change. At this time, the original image can also be processed by color changing based on the color-changing prompt text and the like by the method for image processing in this embodiment, which is different from the processing of changing one color. When the number of the colors to be changed is greater than 1, the original image can be processed by color changing based on the color-changing prompt texts respectively, and through the fusion processing of the generated color-changed image, more than one changed color can be displayed in the final target result image.

Exemplarily, FIG. 1d shows another effect display diagram of the target result image in the method for image processing provided by the embodiment of the present disclosure, and FIG. 1d can also be regarded as an example diagram of a target result image generated by combining the original image shown in FIG. 1b with two color-changing prompt texts by using the method for image processing. As shown in FIG. 1d, in the close-up photo of the character included in the presented target result image, only the color of a hair region as the color-changing object has been changed, and the changed hair presents two colors, which respectively correspond to the color-changing prompt texts of the two changed colors. It can be seen that when there are two colors to be changed, the hair region can be divided into two parts according to the midline of the close-up photo of the character, and the two regions formed by the division present different changed colors respectively. Moreover, it can also be seen that the two different changed colors can be truly and naturally fused, and can also be truly and naturally fused with other contents of the close-up photo of the character.

The method for image processing provided by the embodiment of the present disclosure can automatically generate the color-changing result image matching the content of the color-changing prompt text according to the color-changing requirements only through the original image, the color-changing object mask image in the original image and the color-changing prompt text, so that the image effect is improved and the convenience of editing is enhanced; and through the varying descriptions of the color-changing prompt text, a color-changing solution of simultaneously presenting multiple colors for the equal color-changing object can be realized, so that the flexibility and diversity of color-changing operations are increased; and the fusion of the color-changing result image and the original image ensures the natural transition and coordination between the color-changing object in the finally generated color-changed image and other image contents in the original image, avoiding any abruptness in the color-changed image that might arise from color changing. In this technical solution, a color-changing operation process is simple and flexible, the color of the changed image is saturated and is natural, the diversity and interest of the effect-enhanced gameplay are better expanded and the operation experience of the player is also better improved.

As a first alternative embodiment of this embodiment, on the basis of the above embodiment, the cropping the color-changing object mask image and the original image to obtain respectively a mask cropped image and an original cropped image containing a color-changing object can further include the following concrete steps:
a1) determining a color-changing object position of the color-changing object in the original image, and identifying a target object position of a target object to which the color-changing object belongs in the original image.

In this embodiment, the color-changing object position can be understood as a specific position of the color-changing object in the image that requires color changing, including a coordinate position, a region range, a relative position and a hierarchical position, etc. The color-changing object position can be determined manually by visual recognition, manual selection and other methods, or automatically by image segmentation, machine learning, deep learning and other methods.

In this embodiment, the target object can be considered as a subject object containing a color-changing object, which means that the color-changing object may be a part of the target object, may belong to the category of the target object, and may also be the color-changing object itself. For example, when it is desired to change the hair color of a character in an image, the hair is a color-changing object, and the hair belongs to a part of the head, so the part of the person's head in the image is a target object. The target object can be any part of the image, such as a character, a building, an animal, a vehicle and any other identifiable object.

In this embodiment, the target object position can be understood as a specific position of the target object in the image, and the position information can include a center point of the target object, a bounding box, or more complex shapes to describe the outline of the target object, such as polygons or masks. Exemplarily, in this embodiment, technical means such as image segmentation, target detection, and deep learning may be used to distinguish and identify the color-changing object in the original image, and then determine a position region of the color-changing object and the position region of the target object to which the color-changing object belongs, and store the position information.
b1) determining cropping positions for the color-changing object mask image and the original image according to the color-changing object position, the target object position and set cropping sizes.

In this embodiment, the cropping size can be understood as a width and height of the cropped picture, which can usually be in pixels, for example, 800 pixels wide and 600 pixels high. When cropping, a ratio of width to height of the original image can be maintained, and a new size ratio can be freely selected. In this embodiment, the cropping size can be set according to the size requirements of the big data model used to generate the color-changing result image.

In this embodiment, in order to ensure that the cropped image generated by cropping contains the color-changing object and that the color-changing object can be located in the center of the cropped image, it is necessary to determine the cropping position that meets the cropping requirements (such as the cropping size, the expected position of the color-changing object in the cropped image, etc.) by combining the color-changing object position in the original image and the target object position of the target object associated with the color-changing object in the original image. The cropping position can be expressed by vertex coordinates of a smallest circumscribed rectangle.

In this embodiment, the position region of the target object to which the color-changing object belongs can be determined by determining the position of the color-changing object, and the cropping position information of the color-changing object mask image and the cropping position of the original image can be determined according to the cropping size set for further processing.
c1) cropping respectively the color-changing object mask image and the original image according to the cropping positions and the cropping size to obtain a mask cropped image and an original cropped image, where the mask cropped image and the original cutting image both contain the color-changing object and present the target object in the center.

In this embodiment, the color-changing object mask image and the original image are respectively cropped according to the determined cropping position and the set cropping size, so as to obtain two images with the equal size and position, namely the mask cropped image and the original cropped image. Both cropped images contain the region where the color-changing object is located, and the target object to which the color-changing object belongs is located in the center of the image, where the mask cropped image shows an outline of the color-changing region, while the original cropped image contains the actual image content.

According to the above technical solution of this embodiment, the original image and the color-changing object mask image are cropped according to the positions of the color-changing object and the target object in the original image, as well as the set cropping sizes and the precisely determined cropping positions. This operation can ensure that the color-changing object keeps its proper context and environment in the cropped image, which is crucial for image analysis, editing and further processing. For example, when editing a portrait, ensuring that a face or body parts of the character are presented in the center of the cropped image can make the editing work more concentrated and accurate. In addition, by accurately determining the cropping position and size, the cutting results with the equal cropping size can be obtained from the original image and the mask image. Furthermore, the uniform cropping size helps to standardize an image processing flow, especially when processing a large number of images automatically or in batches, which can significantly improve the efficiency and processing speed.

As a second alternative embodiment of the embodiment of the present disclosure, on the basis of the above optimization, the generating a color-changing result image according to the mask cropped image, the original cropped image and the color-changing prompt text can be specifically optimized to include the following steps:
a2) obtaining an image generation network model that is constructed, and taking the mask cropped image, the original cropped image and the color-changing prompt text as original input information, where the image generation network model includes a noise processing sub-model and an image generation sub-model.

In this embodiment, the image generation network model can be understood as a big data model trained by learning a large amount of data, capable of generating realistic images that match the input content according to the input images and descriptive guidance. Through the image generation network model, the color changing of the region where the color-changing object is located in the original image can be realized. For example, by providing a front picture of a panda and inputting a color-changing prompt text “change part of black fur of the panda to green”, the image generation network model can process the input front picture of the panda and generate a color-changing result image where the black fur is adjusted to green fur.

It should be noted that in the generation of the color-changing image through the image generation network model, the noise processing sub-model is mainly used to determine noise-adding and denoising parameters that match the color-changing region and the non-color-changing region through the analysis of the color-changing prompt text, so as to perform noise-adding and denoising processing on the color-changing region and the non-color-changing region respectively, where a noise feature image generated by only performing noise-adding and denoising processing can already present the changed color in the color-changing region.

However, in an intermediate image only after noise-adding processing and denoising, there is a clear boundary between the changed color of the color-changing object and the contents of other non-color-changing regions in the original cropped image, and there are obvious deviations compared with original pixel information in the original cropped image because other non-color-changing regions in the original cropped image have also been processed by noise-adding and denoising processing.

On such a basis, the image generation sub-model is also introduced into the image generation network model of this embodiment, and the output feature image of the noise processing sub-model can be repaired through the image generation sub-model, specifically, the output feature image can be fused with the original cropped image to generate a more realistic and natural color-changing result image.

The noise processing sub-model can be considered as a part of the image generation network model for processing image noise, which includes one or more groups of noise-adding and denoising network layers. According to the analysis of the content of the color-changing prompt text, the noise processing sub-model can adopt different noise-adding and denoising methods for different types of target regions in the original cropped image, enabling more targeted noise processing. The image generation sub-model can specifically fuse the denoised image with the original cropped image according to the mask cropped image of the color-changing object to generate the color-changing result image after color changing.

In this embodiment, firstly, an architecture of the image generation network model to be used can be determined, such as an AIGC network, which architecture includes a noise processing sub-model and an image generation sub-model; then the network is trained with a large number of prepared training data to obtain the constructed network model after the training is completed; and subsequently, the mask cropped image, the original cropped image and the color-changing prompt text are inputted into the constructed network model.
b2) performing noise-adding and denoising processing on the original cropped image according to the mask cropped image and the color-changing prompt text through at least one group of noise-adding and denoising network layers included in the noise processing sub-model to output a denoised feature map.

In this embodiment, the noise-adding and denoising network layer can be regarded as a deep learning architecture, which is used to automatically add noise to a picture in the input network by a noise-adding network layer, and then try to remove the noise by a denoising network layer. A group of noise-adding and denoising network layers at least includes one noise-adding network layer and one denoising network layer.

In this embodiment, the noise-adding processing can be understood as a process of adding noise to the original cropped image inputted in the noise processing sub-model to simulate various interferences that may be encountered in the real world, so that the network can better learn an internal structure of the image. It can be known that the noise added to the original cropped image can be random, or it can also be selected as needed, such as Gaussian noise, Poisson noise, uniform noise or salt and pepper noise.

In this embodiment, the denoising can be understood as a process of removing unnecessary noise in the image and restoring a definition of the image, and can be regarded as a reverse process of noise-adding processing. A denoising algorithm can be nonlinear, for example, by using a deep learning model, the image containing noise can be processed through feature extraction and a learning ability of a deep neural network to reduce or eliminate the influence of the noise. For example, using a convolutional neural network (CNN) for image denoising can effectively remove Gaussian noise, salt and pepper noise, etc., and restore details and texture information of the image.

In this embodiment, the denoised feature map can be regarded as a feature image generated by image denoising on the image generated by noise-adding processing, and the denoised feature map can be regarded as an image composed of key information or features in the image extracted by a specific algorithm. These feature images contain important information of the original image, but remove the influence of noise, and can be directly used in subsequent processing steps in some applications, such as image recognition or segmentation.

In this embodiment, the color-changing target and the non-color-changing target in the inputted original cropped image are determined according to the mask cropped image and the color-changing prompt text of the input model; meanwhile, according to the requirements of text content description, different regions of the original cropped image are processed by noise-adding and denoising processing in different degrees through the noise processing sub-model, and the noise-adding and denoising processes are repeatedly performed until the last group of noise-adding and denoising network layers in the noise processing sub-model is reached, and the denoised feature map is outputted.

As one of the implementations, in this second alternative embodiment, the outputting a denoised feature map by performing noise-adding and denoising processing on the original cropped image according to the mask cropped image and the color-changing prompt text through at least one group of noise-adding and denoising network layers included in the noise processing sub-model can further specifically include the following steps:
b21) for the noise-adding and denoising network layer, taking the original input information as sub-model input information when the noise-adding and denoising network layer is a first noise-adding and denoising network layer; and taking fusion of the original input information and output information of a previous noise-adding and denoising network layer as sub-model input information, when the noise-adding and denoising network layer is not the first noise-adding and denoising network layer.

In this embodiment, when there is only one group of noise-adding and denoising network layers in the noise processing sub-model, or the noise-adding and denoising network layer is a first noise-adding and denoising network layer in the sub-model, original input information, such as the original image, is directly inputted into the network layer for processing. When there are multiple noise-adding and denoising network layers in the noise processing sub-model, and the current layer is not the first processing layer, information inputted to this layer includes not only original data, but also the output of the previous noise-adding and denoising network layer.

Following the above description, through the above operations, each noise-adding and denoising network layer will receive a processing result of the previous layer, and noise-adding and denoising operations are further performed on this basis. In the noise-adding and denoising network layer being not the first layer, it is necessary to fuse the original input information with the output information of the previous layer. This fusion may involve simple data superposition, weighted averaging, or more complex feature integration strategies, so that the current layer can process on the basis of richer information. In multi-layer processing, each layer may dynamically adjust its own noise-adding and denoising strategy according to the output of the previous layer, to achieve an optimal image quality improvement effect.
b22) determining a color-changing object region feature and a non-color-changing object region feature in the original cropped image according to a mask cropped image feature in the sub-model input information.

In this embodiment, features are identified and extracted from the mask cropped image, which may include an outline, a texture, a color, etc. of the region. These features help to distinguish which regions are color-changing object regions and which are non-color-changing object regions; then, the features extracted from the mask cropped image are applied to the original cropped image. Subsequently, by using the features in the mask cropped image, the corresponding regions are determined in the original cropped image. The color-changing object regions refer to regions marked in the mask image as requiring color changes, while the non-color-changing object regions are other unmarked regions.
b23) directly performing noise-adding processing on the non-color-changing object region feature and performing noise-adding processing on the color-changing object region feature which has been processed by original color elimination, according to the color-changing prompt text.

In this embodiment, through the information provided by the mask cropped image, the regions in the original cropped image can be distinguished, and according to the requirements of the color-changing prompt text, such as a color type, an intensity or other visual effects, the features of the non-color-changing regions and the color-changing regions are processed by different degrees of noise-adding processing. For the non-color-changing object region, noise is directly added to the features of this region, which can be any conventional noise.

Specifically, for the color-changing object region, this embodiment can first perform color removal on features within the region—that is, eliminate or alter the original color—and then add noise to these features in this region. This noise can be the same as that added to the non-color-changing object region or specifically selected based on the color-changing prompt text. For example, noise matching the features after original color removal may be chosen to simulate specific lighting or environmental effects, or a custom noise pattern can be designed for the color-changing region to achieve more realistic or creative results.

Furthermore, according to the requirements of the color-changing prompt text, varying degrees of noise can be applied to different region features. For example, the human hair is processed by color changing, and features of non-hair regions are processed directly according to the mask cropped image of hair.
b24) denoising a noise-added original cropped image that is formed by the noise-adding processing, to generate a denoised feature map as the output information of the noise-adding and denoising network layer.

In this embodiment, the noise-added original cropped image can be understood as an image formed by applying different noise-adding strategies to the features of the color-changing object region and non-color-changing object region in the original cropped image, according to the requirements specified in the color-changing prompt text.

In this embodiment, the original cropped image is processed by noise-adding processing to obtain a noise-added original cropped image, where the image now contains artificially added noise; subsequently, this noise-added image is denoised, and the steps of noise adding and denoising are repeated until the final layer of noise-adding and denoising network layer is reached, and the denoised feature map generated by the last network layer is outputted.

In the technical solution of this embodiment, the technical implementation of generating the denoised feature map by performing multi-stage repeated noise-adding and denoising processing on the features of the color-changing object region and the non-color-changing object region in the original cropped image through the noise sub-model is given. Through the technical solution, random noise in the image can be reduced, so that a clearer image can be obtained; performing noise processing on the color-changing object region and the non-color-changing object region separately allows for more accurate color changes in specific regions of the image while preserving textures and details, ensuring natural color transitions and consistency; multi-stage repeated noise-adding and denoising processing can progressively optimize a feature extraction process, with each step enabling refined adjustments and improvements to image features, thereby improving the final image quality; and the generated denoised feature map assist the model in better reconstructing the color-changed images in subsequent stages.
c2) outputting, through the image generation sub-model, the color-changing result image according to the denoised feature map.

In this embodiment, the denoised feature map serves as an input, the image generation sub-model reads and utilizes the denoised image features to perform operations such as recoloring on the original cropped image, ultimately producing a color-changing result image that is visually similar to the original but with altered colors to meet specific requirements or achieve desired effects.

The above technical solution of this embodiment provides the technical implementation of generating the color-changing result image. The image generation network model that is constructed is obtained to ensure the generation of images that match the color-changing prompt text; based on the color-changing prompt text, the noise processing sub-model within the network model performs multi-stage, region-specific noise-adding and denoising processing on the original cropped image, so that the image features can be adjusted and enhanced in a more refined manner, achieving more accurate color changes in specific regions of the image; and through the image generation sub-model, the color-changing result image is generated from the original cropped image and the denoised feature map, facilitating a natural transition and overall coordination between the color-changing region and the original image.

As one of the implementations, in this second alternative embodiment, the outputting, through the image generation sub-model, the color-changing result image according to the denoised feature map can further specifically include the following steps:
c21) determining the original cropped image, the mask cropped image and the denoised feature map as input data through the image generation sub-model.

In this embodiment, the original cropped image and the mask cropped image that are obtained by cropping the original image and the color-changing object mask image, and the denoised feature map generated by the noise processing sub-model are used as the input data for the image generation sub-model.
c22) performing convolution processing on the mask cropped image, and determining a convolution processing result as a fuzzy coefficient map.

In this embodiment, the fuzzy coefficient map can be understood as a map obtained by convolution processing of the mask cropped image, which can reflect the degree of blur in various regions of the mask cropped image, where each pixel value represents a blur amount of the corresponding region. In this embodiment, the mask cropped image is analyzed by a convolution operation, and a fuzzy coefficient map representing the degree of blur at each position of the image is generated according to a convolution result to guide subsequent image processing operations.
c23) performing weighted fusion on the original cropped image and the denoised feature map using adopting the fuzzy coefficient map, to generate and output the color-changing result image.

In this embodiment, weighting can be considered as adjusting the contribution degree of the original cropped image and the denoised feature map in the fusion process according to the values in the fuzzy coefficient map, and the contribution degree depends on the assigned weight. Weighted fusion can be understood as using specific algorithms, such as convolution or weighted averaging, to determine the weight of each pixel or region, and then calculating the final pixel values of the fused image based on these weights to achieve multi-image fusion.

In this embodiment, the color-changing result image can be regarded as a naturally rendered, color-changed image generated by weighted fusion of the original cropped image and the denoised feature map, taking into account the pixels of the original cropped image and the denoised feature map. It maintains the equal size to the original cropped image. In this embodiment, the fuzzy coefficient map is used as guidance to help determine how to combine the original cropped image with the denoised feature map, thereby generating a color-changing result image that resembles the original image and has undergone color processing.

According to the above technical solution of this embodiment, the technical implementation of performing weighted fusion on the original cropped image and the denoised feature map according to the fuzzy coefficient map to obtain the color-changing result image is given. The above technical solution allows for varying degrees of emphasis based on the importance or features of each pixel, thereby enabling a smoother and more natural transition between the color-changing region and the non-color-changing region, achieving a more seamless color-changing effect on the original cropped image.

As a third alternative embodiment of the embodiment of the present disclosure, on the basis of the above optimization, as an implementation, the determining a target result image according to fusion processing of the color-changing result image and the original image may specifically include the following steps:
a3) upsampling the color-changing result image by using a super-resolution network model to obtain a target color-changing image with the equal image size to the original image.

In this embodiment, the super-resolution network model can be considered as a type of deep learning model specifically designed for image super-resolution, aiming to maintain or enhance image quality while enlarging the image. It usually includes several typical structures, such as a super-resolution convolutional neural network, a deep circular convolution neural network and a sub-pixel convolutional neural network. Up-sampling processing can be understood as an image size enlargement technology, which can increase the number of pixels in the image, thus expanding the size of the image.

In this embodiment, in order to restore the color-changing result image from the size of the cropped image to the target color-changing image with the equal size to the original image, the size of the color-changing result image is enlarged by upsampling by using the super-resolution network model, enabling the color-changing result image to match the original image in size.
b3) performing image fusion on the target color-changing image and the original image by using a set fusion coefficient map to obtain a content-fused image, and generating the target result image according to the content-fused image.

In this embodiment, the fusion coefficient map can be regarded as a preset image with the equal number of coefficients as the number of pixels in the original image, which is used to control the coefficients of the target color-changing image and the pixel feature weights in the original image in an image fusion process, where the coefficient is a numerical value between 0 and 1.

In this embodiment, the content-fused image can be understood as a new image obtained by weighting the target color-changing image and the original image with the fusion coefficient map, followed by image fusion to further adjust visual effects such as color. The new image maintains the equal size to the original image while achieving natural color replacement.

In this embodiment, the target result image can be considered as a color-changed image finally obtained by subjecting the color-changing object to color changing and further performing fusion processing based on the number of content-fused images. This embodiment may determine the identified content-fused image as the target result image when only one content-fused image is generated, or generate the target result image by processing the content-fused images when multiple content-fused images are generated and the color-changing objects in each content-fused image have different colors to be changed.

In this embodiment, in order to restore the obtained color-changing image to the size of the original image, and achieve the effect of natural color changing at this size, the target color-changing image and the original image are processed by weighted fusion by using an appropriate fusion coefficient map on the basis of restoring the size through an upsampling operation by the super-resolution network, thereby obtaining a content-fused image that retains the original size and has a natural color transition effect.

It can be understood that because there may be multiple color-changing requirements, there may be multiple color-changing prompt texts. For example, when the color-changing requirement is for the hair to have both red and green, then the corresponding color-changing prompt texts would be “change the hair color to red” and “change the hair color to green” respectively. When inputting the constructed image generation network, two color-changing prompt texts are respectively inputted together with other input data, and corresponding color-changing operations are performed, so that one color-changing requirement will generate one color-changing result image, and the number of color-changing result images is the same as that of color-changing prompt texts. When restoring the original size, the color-changing result images are also processed one by one, so that the number of content-fused images obtained will be the same as that of color-changing result images. Finally, according to the number of the content-fused images generated, different processing methods are adopted to finally generate a unique target result image.

The above technical solution of this embodiment provides the technical implementation of restoring the color-changing result image from the size of the cropped image to the equal size to the original image. Upsampling processing is performed by the super-resolution network model, and the target color-changing image and the original image are fused by using the fusion coefficient, so that the color-changing image can restore the size of the original image, and the color-changing effect is natural and coordinated.

On the basis of this third alternative embodiment, the generating the target result image according to the content-fused image can further specifically include the following steps:
b31) when a number of the content-fused image is 1, determining the content-fused image as the target result image.

Exemplarily, when only one content-fused image is determined, the content-fused image can be determined as the final target result image.
b32) when the number of the content-fused images is greater than or equal to 2, determining a to-be-fused region of each content-fused image relative to the original image according to key feature points detected from the original image, and forming a to-be-fused mask image containing each to-be-fused region.

In this embodiment, when there are multiple determined content-fused images, the target result image can be obtained by processing the multiple content-fused images through this step and the following steps. The key feature points can be understood as feature points that can characterize the target object in the original image, and when the target object is a character, the key feature points can be considered as feature points that can characterize the head and face of the character.

In this embodiment, the to-be-fused region can be considered as a specific region in the content-fused image that needs to be fused to the original image by analyzing positions of these detected key feature points in the content-fused image and their corresponding positions in the original image. The to-be-fused mask image can be regarded as a binary mask image containing information of all to-be-fused regions, which is used to distinguish the to-be-fused region from other regions.

Specifically, when multiple content-fused images are obtained by inputting network data, the original images are first detected to determine the key feature points in the original images; according to the detected key feature points, positions of these points in the content-fused images and their corresponding positions in the original image are analyzed; according to the positions corresponding to the key feature points, specific regions in the content-fused images that need to be fused in original image, that is, to-be-fused regions, are delineated; and based on the determined to-be-fused regions, a binary mask image containing information of all the to-be-fused regions is formed.

Exemplarily, when the user attempts to fuse one portrait with green hair with another portrait with red hair to finally get a hair effect of the portrait with half green and half red hair, then a face in the original image can be detected and a number of key points are obtained, such as 106; through these key points, the position of the human face in the original image can be analyzed, and according to feature points located on a center line of the human face, such as the 43rd and 44th points, a connecting line of these two points is drawn, which is a vertical line in the middle of a nose; at this time, this line can be taken as a dividing line to divide the human face into a left part and a right part, facilitating the creation of a natural and coordinated half-green, half-red hairstyle effect; when a hair color of an original image is black, a hair color of a content-fused image 1 is red, and a hair color of a content-fused image 2 is green, the content-fused image 1 can retain its hair color of one half as red while the hair color of the other half is fused with that of the content-fused image 2; optionally, when the content-fused image 1 keeps its left-side hair color, then the to-be-fused region is the right-side hair, and the right side of a segmentation plane of the binary mask image formed at this time is all 0, and the rest of the image is all 1.
b33) performing image fusion on the to-be-fused mask image and each content-fused images to generate a fused target result image.

In this embodiment, the to-be-fused mask image, as a guide for the fusion process, separately manages a fusion portion of each image with the original image, ensuring that the fusion operation is performed only within a designated region to be fused, rather than the entire image. The to-be-fused mask image is processed as the weight of each content-fused image, and optionally, the to-be-fused mask image can be processed by Gaussian smoothing. The weighted content-fused images are fused to generate a fused image, that is, a target result image.

The technical solution described in this embodiment provides a technical implementation for processing one or more content-fused images to generate a final unique target result image. Through the technical solution, the effect of fusing the multiple content-fused images efficiently, flexibly and naturally into a unique target result image after color changing is realized by using the key feature points and the to-be-fused mask image, and the diversity of color-changing effects is enhanced.

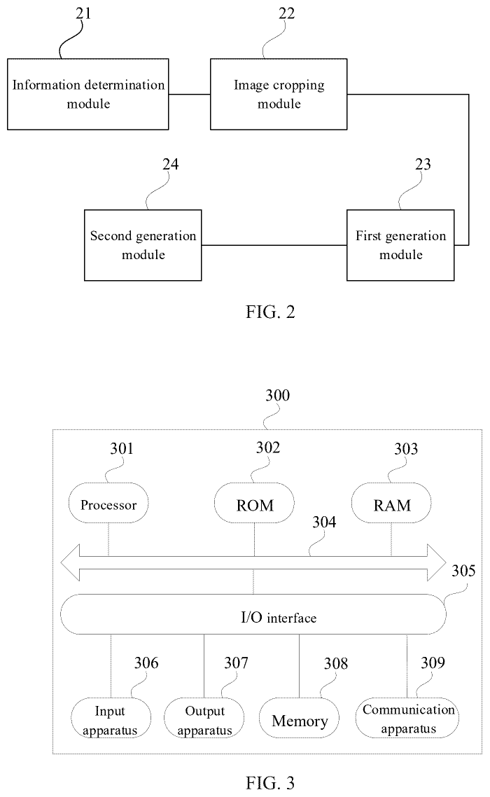

FIG. 2 is a schematic structural diagram of an image processing apparatus provided by an embodiment of the present disclosure. As shown in FIG. 2, the apparatus may include: an information determination module 21, an image cropping module 22, a first generation module 23 and a second generation module 24.

The information determination module 21 is configured to obtain an original image and a color-changing prompt text, and determine a color-changing object mask image of the original image;
the image cropping module 22 is configured to crop the color-changing object mask image and the original image to obtain respectively a mask cropped image and an original cropped image containing a color-changing object;
the first generation module 23 is configured to generate a color-changing result image according to the mask cropped image, the original cropped image and the color-changing prompt text; and
the second generation module 24 is configured to generate a target result image according to fusion processing of the color-changing result image and the original image.

The image processing apparatus provided by the embodiment of the present disclosure can automatically generate the color-changing result image matching the content of the color-changing prompt text only through the original image, the mask image of the color-changing object within the original image, and the color-changing prompt text, so that the convenience of image effect enhancement editing is enhanced; and through the varying descriptions of the color-changing prompt text, a color-changing solution of simultaneously presenting multiple colors for the equal color-changing object can be realized, so that the flexibility and diversity of color-changing operations are increased; and the fusion of the color-changing result image with the original image ensures the natural transition and coordination between the color-changing object in the finally generated color-changed image and other image content in the original image, avoiding any abruptness in the color-changed image that might arise from color changing. In this technical solution, a color-changing operation process is simple and flexible, the color of the changed image is saturated and is natural, the diversity and interest of the effect-enhanced gameplay are better expanded and the operation experience of the player is also better improved.

Further, the image cropping module 22 may be specifically configured to:
determine a color-changing object position of the color-changing object in the original image, and identify a target object position of a target object to which the color-changing object belongs in the original image;
determine cropping sizes and cropping positions in the color-changing object mask image and the original image according to the color-changing object position and the target object position; and
crop respectively the color-changing object mask image and the original image according to the cropping positions and the cropping size to obtain a mask cropped image and an original cropped image, where the mask cropped image and the original cutting image both contain the color-changing object and present the target object in the center.

Further, the first generation module 23 may specifically include:
a model obtaining unit configured to obtain an image generation network model that is constructed, and taking the mask cropped image, the original cropped image and the color-changing prompt text as original input information, where the image generation network model includes a noise processing sub-model and an image generation sub-model;
a first output unit configured to perform noise-adding and denoising processing on the original cropped image according to the mask cropped image and the color-changing prompt text through at least one group of noise-adding and denoising network layers included in the noise processing sub-model to output a denoised feature map; and
a second output unit configured to output, through the image generation sub-model, the color-changing result image according to the denoised feature map.

Further, the first output unit may be specifically configured to:
for the noise-adding and denoising network layer, take the original input information as unit input information when the noise-adding and denoising network layer is a first noise-adding and denoising network layer; and take fusion information of the original input information and output information of a previous noise-adding and denoising network layer as unit input information, when the noise-adding and denoising network layer is not the first noise-adding and denoising network layer;
determine a color-changing object region feature and a non-color-changing object region feature in the original cropped image according to a mask cropped image feature in the unit input information processed by noise processing;
directly perform noise-adding processing on the non-color-changing object region feature and perform noise-adding processing on the color-changing object region feature which has been processed by original color elimination, according to the color-changing prompt text; and
denoise a noise-added original cropped image that is formed by the noise-adding processing, to generate a denoised feature map as the output information of the noise-adding and denoising network layer.

Further, the second output unit may be specifically configured to:
determine the original cropped image, the mask cropped image and the denoised feature map as input data through the image generation sub-model;
perform convolution processing on the mask cropped image, and determine a convolution processing result as a fuzzy coefficient map; and
perform weighted fusion on the original cropped image and the denoised feature map using adopting the fuzzy coefficient map, to generate and output the color-changing result image.

Further, the second generation module 24 may specifically include:
a first processing unit configured to upsample the color-changing result image by using a super-resolution network model to obtain a target color-changing image with the equal image size to the original image; and
a second processing unit configured to perform image fusion on the target color-changing image and the original image by using a set fusion coefficient map to obtain a content-fused image, and generate the target result image according to the content-fused image.

Further, the second processing unit may be specifically configured to:
perform image fusion on the target color-changing image and the original image by using a set fusion coefficient map to obtain a content-fused image;
when a number of the content-fused image is 1, determine the content-fused image as the target result image;
when the number of the content-fused images is greater than or equal to 2, determine a to-be-fused region of each content-fused image relative to the original image according to key feature points detected from the original image, and form a to-be-fused mask image containing each to-be-fused region; and
perform image fusion on the to-be-fused mask image and each content-fused image to generate a fused target result image.

The image processing apparatus provided by the embodiment of the present disclosure can execute the method for image processing provided by any embodiment of the present disclosure, and has corresponding functional modules and beneficial effects.

It is worth noting that the various units and modules included in the above apparatus are only divided according to functional logics, but not limited thereto, as long as the corresponding functions can be implemented; in addition, the specific names of the functional units are only for the convenience of distinguishing between each other, and are not used to limit the protection scope of the embodiments of the present disclosure.

FIG. 3 is a schematic structural diagram of an electronic device provided by an embodiment of the present disclosure. Referring to FIG. 3 below, it shows a structural schematic diagram of an electronic device (such as the terminal device or server in FIG. 3) 300 suitable for implementing the embodiments of the present disclosure. The terminal devices in the embodiments of the present disclosure may include but are not limited to mobile terminals such as mobile phones, laptop computers, digital broadcast receivers, PDAs (personal digital assistants), PADs (tablet computers), PMPs (portable multimedia players), vehicle-mounted terminals (such as vehicle navigation terminals), and fixed terminals such as digital TVs and desktop computers. The electronic device shown in FIG. 3 is only an example and should not impose any restrictions on the functions and scope of use of the embodiments of the present disclosure.

As shown in FIG. 3, the electronic device 300 may include a processor (such as a central processing unit, graphics processing unit, etc.) 301, which can execute various appropriate actions and processing according to programs stored in a read-only memory (ROM) 302 or programs loaded from a memory 308 into a random access memory (RAM) 303. The RAM 303 also stores various programs and data required for the operation of the electronic device 300. The processor 301, ROM 302, and RAM 303 are connected to each other through a bus 304. An Input/output (I/O) interface 305 is also connected to the bus 304.

Generally, the following apparatuses may be connected to the I/O interface 305: an input apparatus 306 including, for example, a touch screen, touchpad, keyboard, mouse, camera, microphone, accelerometer, gyroscope, etc.; an output apparatus 307 including, for example, a liquid crystal display (LCD), speaker, vibrator, etc.; the memory 308 including, for example, a magnetic tape, hard disk, etc.; and a communication apparatus 309. The communication apparatus 309 may allow the electronic device 300 to communicate wirelessly or via a cable with other devices to exchange data. Although FIG. 3 shows an electronic device 300 with various apparatuses, it should be understood that it is not required to implement or have all the shown apparatuses. More or fewer apparatuses may alternatively be implemented or provided.

In particular, according to an embodiment of the present disclosure, the processes described above with reference to the flowcharts may be implemented as computer software programs. For example, the embodiments of the present disclosure include a computer program product includes a computer program carried on a non-transitory computer-readable medium, the computer program containing program code for executing the methods shown in the flowcharts. In such an embodiment, the computer program may be downloaded and installed from a network via the communication apparatus 309, or installed from the memory 308, or installed from the ROM 302. When the computer program is executed by the processor 301, the above-described functions defined in the methods of the embodiments of the present disclosure are performed.

The names of messages or information interacted between multiple apparatuses in the implementation manners of the present disclosure are for illustrative purposes only and are not intended to limit the scope of these messages or information.

The electronic device provided in the embodiments of the present disclosure belongs to the same inventive concept as the image processing method provided in the above embodiments. Technical details not elaborated in this embodiment may be referred to in the above embodiments, and this embodiment has the same beneficial effects as the above embodiments.

The embodiments of the present disclosure provide a computer storage medium on which a computer program is stored, and when the program is executed by a processor, it implements the image processing method provided in the above embodiments.

It should be noted that the computer-readable medium described above in the present disclosure may be a computer-readable signal medium or a computer-readable storage medium, or any combination of the two. A computer-readable storage medium may be, for example, but not limited to, an electrical, magnetic, optical, electromagnetic, infrared, or semiconductor system, apparatus, or device, or any combination thereof. More specific examples of the computer-readable storage medium may include but are not limited to: an electrical connection with one or more wires, a portable computer disk, a hard disk, a random access memory (RAM), a read-only memory (ROM), an erasable programmable read-only memory (EPROM or Flash memory), an optical fiber, a portable compact disk read-only memory (CD-ROM), an optical memory, a magnetic memory, or any suitable combination of the above. In the present disclosure, a computer-readable storage medium may be any tangible medium that contains or stores a program for use by or in combination with an instruction execution system, apparatus, or device. In the present disclosure, a computer-readable signal medium may include a data signal propagated in baseband or as part of a carrier wave, in which computer-readable program code is carried. Such a propagated data signal may take various forms, including but not limited to an electromagnetic signal, an optical signal, or any suitable combination thereof. The computer-readable signal medium may also be any computer-readable medium other than the computer-readable storage medium, which can send, propagate, or transmit a program for use by or in combination with an instruction execution system, apparatus, or device. The program code contained on the computer-readable medium may be transmitted by any appropriate medium, including but not limited to a wire, an optical cable, an RF (radio frequency), etc., or any suitable combination of the above.

In some implementations, the client and server may communicate using any currently known or future-developed network protocol such as HTTP (HyperText Transfer Protocol), and may be interconnected with any form or medium of digital data communication (e.g., a communication network). Examples of communication networks include a local area network (“LAN”), a wide area network (“WAN”), the Internet (e.g., the Internet), and peer-to-peer networks (e.g., an ad hoc peer-to-peer network), as well as any currently known or future-developed networks.

The above-mentioned computer-readable medium may be included in the above-mentioned electronic device; or it may exist separately without being assembled into the electronic device.

The above-mentioned computer-readable medium carries one or more programs, and when the one or more programs are executed by the electronic device, the electronic device is caused to perform obtaining an original image and color-change prompt text, and determining a color-change object mask image of the original image; cropping the color-change object mask image and the original image to respectively obtain a mask cropped image and an original cropped image containing a color-change object; generating a color-change result image according to the mask cropped image, the original cropped image, and the color-change prompt text; and generating a target result image according to the fusion processing of the color-change result image and the original image.

Computer program code for performing the operations of the present disclosure may be written in one or more programming languages or combinations thereof, including but not limited to object-oriented programming languages such as Java, Smalltalk, C++, and conventional procedural programming languages such as the “C” language or similar programming languages. The program code may execute entirely on the user's computer, partly on the user's computer, execute as a stand-alone software package, partly on the user's computer and partly on a remote computer, or execute entirely on the remote computer or server. In the case of a remote computer, the remote computer may be connected to the user's computer through any type of network, including a local area network (LAN) or a wide area network (WAN), or may be connected to an external computer (e.g., via the Internet using an Internet service provider).

The flowcharts and block diagrams in the accompanying drawings illustrate the possible implementation architectures, functions, and operations of systems, methods, and computer program products according to various embodiments of the present disclosure. In this regard, each block in the flowchart or block diagram may represent a module, program segment, or part of code, which contains one or more executable instructions for implementing the specified logical function(s). It should also be noted that, in some alternative implementations, the functions noted in the block may occur out of the order noted in the drawings. For example, two blocks shown in succession may, in fact, be executed substantially in parallel, or they may sometimes be executed in the reverse order, depending upon the functionality involved. It should also be noted that each block of the block diagrams and/or flowchart illustrations, and combinations of blocks in the block diagrams and/or flowchart illustrations, may be implemented by special purpose hardware-based systems that perform the specified functions or operations, or by combinations of special purpose hardware and computer instructions.

The units involved in the embodiments of the present disclosure may be implemented by software or by hardware. Among them, the name of a unit does not constitute a limitation on the unit itself in some cases. For example, the first acquisition unit may also be described as a “unit for acquiring at least two Internet protocol addresses.”

The functions described above in the present disclosure may be performed at least in part by one or more hardware logic components. For example, without limitation, exemplary types of hardware logic components that may be used include: field programmable gate arrays (FPGAs), application specific integrated circuits (ASICs), application specific standard products (ASSPs), system on chips (SOCs), complex programmable logic devices (CPLDs), and the like.

In the context of the present disclosure, a machine-readable medium may be a tangible medium that can contain or store a program for use by or in combination with an instruction execution system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination of the foregoing.

The above description is only a preferred embodiment of the present disclosure and an explanation of the applied technical principles. Those skilled in the art should understand that the scope of the disclosure involved in the present disclosure is not limited to the specific technical solutions formed by the specific combinations of the above technical features, but should also cover other technical solutions formed by any combination of the above technical features or their equivalent features without departing from the inventive concept. For example, technical solutions formed by replacing the above features with technical features having similar functions disclosed in the present disclosure (but not limited to) are within the scope of the present disclosure.

In addition, although the operations are depicted in a specific order, this should not be understood as requiring that such operations be performed in the specific order shown or in sequential order. In certain environments, multitasking and parallel processing may be advantageous. Similarly, although several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments separately or in any suitable subcombination.

Although the subject matter has been described in language specific to structural features and/or methodological logical acts, it should be understood that the subject matter defined in the appended claims is not necessarily limited to the specific features or acts described above. Rather, the specific features and acts described above are disclosed as example forms of implementing the claims.

1. A method for image processing, comprising:
obtaining an original image and a color-changing prompt text, and determining a color-changing object mask image of the original image;
cropping the color-changing object mask image and the original image to obtain respectively a mask cropped image and an original cropped image containing a color-changing object;
generating a color-changing result image according to the mask cropped image, the original cropped image and the color-changing prompt text; and
generating a target result image according to fusion processing of the color-changing result image and the original image.

2. The method according to claim 1, wherein the cropping the color-changing object mask image and the original image to obtain respectively a mask cropped image and an original cropped image containing a color-changing object comprises:
determining a color-changing object position of the color-changing object in the original image, and identifying a target object position of a target object to which the color-changing object belongs in the original image;
determining cropping positions for the color-changing object mask image and the original image according to the color-changing object position, the target object position and set cropping size; and
cropping respectively the color-changing object mask image and the original image according to the cropping positions and the cropping size to obtain a mask cropped image and an original cropped image, wherein the mask cropped image and the original cutting image both contain the color-changing object and present the target object in center.

3. The method according to claim 1, wherein the generating a color-changing result image according to the mask cropped image, the original cropped image and the color-changing prompt text comprises:
obtaining an image generation network model that is constructed, and taking the mask cropped image, the original cropped image and the color-changing prompt text as original input information, wherein the image generation network model comprises a noise processing sub-model and an image generation sub-model;
performing noise-adding and denoising processing on the original cropped image according to the mask cropped image and the color-changing prompt text through at least one group of noise-adding and denoising network layers comprised in the noise processing sub-model to output a denoised feature map; and
outputting, through the image generation sub-model, the color-changing result image according to the denoised feature map.

4. The method according to claim 3, wherein the performing noise-adding and denoising processing on the original cropped image according to the mask cropped image and the color-changing prompt text through at least one group of noise-adding and denoising network layers comprised in the noise processing sub-model to output a denoised feature map comprises:
for a noise-adding and denoising network layer, taking the original input information as sub-model input information when the noise-adding and denoising network layer is a first noise-adding and denoising network layer;
and taking fusion of the original input information and output information of a previous noise-adding and denoising network layer as the sub-model input information, when the noise-adding and denoising network layer is not the first noise-adding and denoising network layer;
determining a color-changing object region feature and a non-color-changing object region feature in the original cropped image according to a mask cropped image feature in the sub-model input information;
directly performing noise-adding processing on the non-color-changing object region feature and performing noise-adding processing on the color-changing object region feature which has been processed by original color elimination, according to the color-changing prompt text; and
denoising a noise-added original cropped image that is formed by the noise-adding processing, to generate a denoised feature map as the output information of the noise-adding and denoising network layer.

5. The method according to claim 3, wherein the outputting, through the image generation sub-model, the color-changing result image according to the denoised feature map comprises:
determining the original cropped image, the mask cropped image and the denoised feature map as input data through the image generation sub-model;
performing convolution processing on the mask cropped image, and determining a convolution processing result as a fuzzy coefficient map; and
performing weighted fusion on the original cropped image and the denoised feature map using adopting the fuzzy coefficient map, to generate and output the color-changing result image.

6. The method according to claim 1, wherein the generating a target result image according to fusion processing of the color-changing result image and the original image comprises:
upsampling the color-changing result image by using a super-resolution network model to obtain a target color-changing image with an equal image size to the original image; and
performing image fusion on the target color-changing image and the original image by using a set fusion coefficient map to obtain a content-fused image, and generating the target result image according to the content-fused image.

7. The method according to claim 6, wherein the generating the target result image according to the content-fused image comprises:
when a number of the content-fused image is 1, determining the content-fused image as the target result image;
when the number of the content-fused images is greater than or equal to 2, determining a to-be-fused region of each content-fused image relative to the original image according to key feature points detected from the original image, and forming a to-be-fused mask image containing each to-be-fused region; and
performing image fusion on the to-be-fused mask image and each content-fused image to generate a fused target result image.

8. An electronic device, comprising:
at least one processor; and
a storage apparatus configured to store at least one program,
wherein when the at least one program is executed by the at least one processor, the at least one processor is caused to implement a method for image processing, and the method comprises:
obtaining an original image and a color-changing prompt text, and determining a color-changing object mask image of the original image;
cropping the color-changing object mask image and the original image to obtain respectively a mask cropped image and an original cropped image containing a color-changing object;
generating a color-changing result image according to the mask cropped image, the original cropped image and the color-changing prompt text; and
generating a target result image according to fusion processing of the color-changing result image and the original image.

9. The electronic device according to claim 8, wherein the cropping the color-changing object mask image and the original image to obtain respectively a mask cropped image and an original cropped image containing a color-changing object comprises:
determining a color-changing object position of the color-changing object in the original image, and identifying a target object position of a target object to which the color-changing object belongs in the original image;
determining cropping positions for the color-changing object mask image and the original image according to the color-changing object position, the target object position and set cropping size; and
cropping respectively the color-changing object mask image and the original image according to the cropping positions and the cropping size to obtain a mask cropped image and an original cropped image, wherein the mask cropped image and the original cutting image both contain the color-changing object and present the target object in center.

10. The electronic device according to claim 8, wherein the generating a color-changing result image according to the mask cropped image, the original cropped image and the color-changing prompt text comprises:
obtaining an image generation network model that is constructed, and taking the mask cropped image, the original cropped image and the color-changing prompt text as original input information, wherein the image generation network model comprises a noise processing sub-model and an image generation sub-model;
performing noise-adding and denoising processing on the original cropped image according to the mask cropped image and the color-changing prompt text through at least one group of noise-adding and denoising network layers comprised in the noise processing sub-model to output a denoised feature map; and
outputting, through the image generation sub-model, the color-changing result image according to the denoised feature map.

11. The electronic device according to claim 10, wherein the performing noise-adding and denoising processing on the original cropped image according to the mask cropped image and the color-changing prompt text through at least one group of noise-adding and denoising network layers comprised in the noise processing sub-model to output a denoised feature map comprises:
for a noise-adding and denoising network layer, taking the original input information as sub-model input information when the noise-adding and denoising network layer is a first noise-adding and denoising network layer;
and taking fusion of the original input information and output information of a previous noise-adding and denoising network layer as the sub-model input information, when the noise-adding and denoising network layer is not the first noise-adding and denoising network layer;
determining a color-changing object region feature and a non-color-changing object region feature in the original cropped image according to a mask cropped image feature in the sub-model input information;
directly performing noise-adding processing on the non-color-changing object region feature and performing noise-adding processing on the color-changing object region feature which has been processed by original color elimination, according to the color-changing prompt text; and
denoising a noise-added original cropped image that is formed by the noise-adding processing, to generate a denoised feature map as the output information of the noise-adding and denoising network layer.

12. The electronic device according to claim 10, wherein the outputting, through the image generation sub-model, the color-changing result image according to the denoised feature map comprises:
determining the original cropped image, the mask cropped image and the denoised feature map as input data through the image generation sub-model;
performing convolution processing on the mask cropped image, and determining a convolution processing result as a fuzzy coefficient map; and
performing weighted fusion on the original cropped image and the denoised feature map using adopting the fuzzy coefficient map, to generate and output the color-changing result image.

13. The electronic device according to claim 8, wherein the generating a target result image according to fusion processing of the color-changing result image and the original image comprises:
upsampling the color-changing result image by using a super-resolution network model to obtain a target color-changing image with an equal image size to the original image; and
performing image fusion on the target color-changing image and the original image by using a set fusion coefficient map to obtain a content-fused image, and generating the target result image according to the content-fused image.

14. The electronic device according to claim 13, wherein the generating the target result image according to the content-fused image comprises:
when a number of the content-fused image is 1, determining the content-fused image as the target result image;
when the number of the content-fused images is greater than or equal to 2, determining a to-be-fused region of each content-fused image relative to the original image according to key feature points detected from the original image, and forming a to-be-fused mask image containing each to-be-fused region; and
performing image fusion on the to-be-fused mask image and each content-fused image to generate a fused target result image.

15. A non-transitory computer-readable storage medium having stored thereon a computer program, wherein the program, when executed by a processor, implements a method for image processing, and the method comprises:
obtaining an original image and a color-changing prompt text, and determining a color-changing object mask image of the original image;
cropping the color-changing object mask image and the original image to obtain respectively a mask cropped image and an original cropped image containing a color-changing object;
generating a color-changing result image according to the mask cropped image, the original cropped image and the color-changing prompt text; and
generating a target result image according to fusion processing of the color-changing result image and the original image.

16. The non-transitory computer-readable storage medium according to claim 15, wherein the cropping the color-changing object mask image and the original image to obtain respectively a mask cropped image and an original cropped image containing a color-changing object comprises:
determining a color-changing object position of the color-changing object in the original image, and identifying a target object position of a target object to which the color-changing object belongs in the original image;
determining cropping positions for the color-changing object mask image and the original image according to the color-changing object position, the target object position and set cropping size; and
cropping respectively the color-changing object mask image and the original image according to the cropping positions and the cropping size to obtain a mask cropped image and an original cropped image, wherein the mask cropped image and the original cutting image both contain the color-changing object and present the target object in center.

17. The non-transitory computer-readable storage medium according to claim 15, wherein the generating a color-changing result image according to the mask cropped image, the original cropped image and the color-changing prompt text comprises:
obtaining an image generation network model that is constructed, and taking the mask cropped image, the original cropped image and the color-changing prompt text as original input information, wherein the image generation network model comprises a noise processing sub-model and an image generation sub-model;
performing noise-adding and denoising processing on the original cropped image according to the mask cropped image and the color-changing prompt text through at least one group of noise-adding and denoising network layers comprised in the noise processing sub-model to output a denoised feature map; and
outputting, through the image generation sub-model, the color-changing result image according to the denoised feature map.

18. The non-transitory computer-readable storage medium according to claim 17, wherein the performing noise-adding and denoising processing on the original cropped image according to the mask cropped image and the color-changing prompt text through at least one group of noise-adding and denoising network layers comprised in the noise processing sub-model to output a denoised feature map comprises:
for a noise-adding and denoising network layer, taking the original input information as sub-model input information when the noise-adding and denoising network layer is a first noise-adding and denoising network layer; and taking fusion of the original input information and output information of a previous noise-adding and denoising network layer as the sub-model input information, when the noise-adding and denoising network layer is not the first noise-adding and denoising network layer;
determining a color-changing object region feature and a non-color-changing object region feature in the original cropped image according to a mask cropped image feature in the sub-model input information;
directly performing noise-adding processing on the non-color-changing object region feature and performing noise-adding processing on the color-changing object region feature which has been processed by original color elimination, according to the color-changing prompt text; and
denoising a noise-added original cropped image that is formed by the noise-adding processing, to generate a denoised feature map as the output information of the noise-adding and denoising network layer.

19. The non-transitory computer-readable storage medium according to claim 17, wherein the outputting, through the image generation sub-model, the color-changing result image according to the denoised feature map comprises:
determining the original cropped image, the mask cropped image and the denoised feature map as input data through the image generation sub-model;
performing convolution processing on the mask cropped image, and determining a convolution processing result as a fuzzy coefficient map; and
performing weighted fusion on the original cropped image and the denoised feature map using adopting the fuzzy coefficient map, to generate and output the color-changing result image.

20. The non-transitory computer-readable storage medium according to claim 15, wherein the generating a target result image according to fusion processing of the color-changing result image and the original image comprises:
upsampling the color-changing result image by using a super-resolution network model to obtain a target color-changing image with an equal image size to the original image; and
performing image fusion on the target color-changing image and the original image by using a set fusion coefficient map to obtain a content-fused image, and generating the target result image according to the content-fused image.
